(19) United States
(12) Patent Application Publication
(10) Pub. No.: US 2014/0199075 A1
(43) Pub. Date: Jul. 17, 2014

(54) APPARATUS AND METHOD FOR CONTROLLING MULTICARRIER LIGHT SOURCE GENERATOR

(71) Applicant: Electronics and Telecommunications Research Institute, Daejeon (KR)

(72) Inventors: Joon-Young HUH, Daejeon-si (KR); Sun-Hyok CHANG, Daejeon-si (KR); Hwan-Seok CHUNG, Daejeon-si (KR); Kwang-Joon KIM, Daejeon-si (KR); Jong-Hyun LEE, Daejeon-si (KR)

(73) Assignee: Electronics and Telecommunications Research Institute, Daejeon (KR)

(21) Appl. No.: 14/152,449

(22) Filed: Jan. 10, 2014

(30) Foreign Application Priority Data
Jan. 16, 2013 (KR) 10-2013-0005058

(51) Int. Cl. H04J 14/02; H04B 10/50

(52) U.S. Cl. CPC H04J 14/0227; H04B 10/506
USPC 398/79

(57) ABSTRACT

An apparatus and method for controlling a multicarrier light source generator are provided. The apparatus includes N-light source input units configured to input light sources to a multicarrier light source generator that generates multicarrier light sources at a frequency interval of F [Hz], and a control unit configured to adjust the frequency interval of the multicarrier light sources generated from the multicarrier light source generator, by adjusting a frequency interval between the light sources input from the N-light source input unit as F/N [Hz].

### CROSS-REFERENCE TO RELATED APPLICATION

This application claims the benefit under 35 U.S.C. §119(a) of a Korean Patent Application No. 10-2013-0005058, filed on Jan. 16, 2013, in the Korean Intellectual Property Office, the entire disclosure of which is incorporated herein by reference for all purposes.

### BACKGROUND

1. Field

The following description relates to a technology for controlling a multicarrier light source generator that is used in an optical communication system, and more particularly, to a technology for freely adjusting a channel interval of a multicarrier light source generator.

2. Description of the Related Art

The popularization of smartphones and the development of a social network result in the increase of Internet traffic, and in order to solve such a drawback, consistent efforts have been made to provide for high capacity and high speed of a network that mainly uses an optical communication. A representative example of the efforts is a wavelength division multiplexing (hereinafter, referred to as WDM) that multiplexes optical signals having different wavelengths in a single optical fiber. The WDM may remarkably increase the capacity of an optical network using several tens to several hundreds of wavelengths within an available band of active elements used in the optical network, for example, an optical amplifier.

However, there is a disadvantage that the WDM needs to have light sources having available wavelengths, and wavelengths of several tens to several hundreds of light sources need to be finely adjusted and managed. In order to solve such a disadvantage, a multicarrier generating technique is provided to generate carries having various wavelengths using elements, for example, a nonlinear element and a modulator. The multicarrier generating technology is mainly divided into two types, a method using a nonlinear effect generated from a nonlinear element and a method using the combination of modulators.

In the method using a non-linear element, when a clock light source having a periodicity is input into a silica nanowire and a nonlinear optical fiber, nonlinear effects, such as a four-wave mixing, a cross-phase modulation, and a self-phase modulation, occur by the characteristics of nonlinear elements, and the combination of the nonlinear effects is changed to combinations of light sources having several hundreds to several thousands of wavelengths, for example, a supercontinuum. This method has a benefit that light sources are generated up to several thousands depending on the characteristic of the nonlinear element, but has a constraint that the characteristics of the used nonlinear element need to be finely adjusted.

In the method using an optical modulator, light sources having several tens of wavelengths are generated through the combination of carrier components generated when an optical signal is modulated using phase modulators or intensity modulators. This method has a benefit that light sources having several to several tens of wavelengths are generated depending on the used modulator, and an interval between wavelengths is finely adjusted. However, due to the limitation of characteristics of a modulator, the number of wavelengths generated is limited.

### SUMMARY

The following description relates to an apparatus and method for controlling a multicarrier light source generator capable of freely adjusting an interval between wavelengths of generated light sources.

In one general aspect, an apparatus for controlling a multicarrier light source generator includes N-light source input units and a control unit. The N-light source input units may be configured to input light sources to a multicarrier light source generator that generates multicarrier light sources at a frequency interval of F [Hz]. The control unit may be configured to adjust the frequency interval of the multicarrier light sources generated from the multicarrier light source generator, by adjusting a frequency interval between the light sources input from the N-light source input unit as F/N [Hz].

The control unit may select a light source, which is to be input into the multicarrier light source generator, among light sources generated from the N-light source input units by selectively switching on/off the N-light source input units, such that the frequency interval between the multicarrier light sources generated from the multicarrier light source generator is adjusted.

The control unit may adjust the frequency interval between the multicarrier light sources generated from the multicarrier light source generator as kF/N [Hz] (1≦k≦N, k is an integer and a divisor of N) by selectively switching on/off the N-light source input units.

The control unit, when selecting a light source which is to be input into the multicarrier light source generator, may select the light source based on a frequency or a frequency interval that is desired by a user command.

The control unit may adjust wavelengths and intensities of light sources that are input into the multicarrier light source generator, by controlling an operation of the N-light source input units.

The apparatus may further include an optical combiner configured to combine light sources generated from the N-light source input units, and input the combined light sources into the multicarrier light source generator.

In another general aspect, a method of controlling a multicarrier light source generator includes adjusting a frequency interval of light sources as F/N [Hz], and adjusting a frequency interval of multicarrier light sources generated from a multicarrier light source generator that generates multicarrier light sources at a frequency interval of F [Hz], by inputting the light sources, the frequency interval of which is adjusted, into the multicarrier light source generator through N-light source input units.

As is apparent from the above, by applying the apparatus and method for controlling the multicarrier light source generator in accordance with an embodiment of the present disclosure to a general multicarrier light source generator that generates multicarrier light sources, a frequency interval between the generated multicarrier light sources can be freely adjusted. That is, a control circuit that shares states of N-light sources with the N-light sources and adjusts the states is added and applied to a multicarrier light source generator, so that if only the respective light sources are selectively activated, the frequency interval between the multicarrier light sources can be freely adjusted.

Other features and aspects will be apparent from the following detailed description, the drawings, and the claims.

### BRIEF DESCRIPTION OF THE DRAWINGS

FIG. 1 is a block diagram illustrating an apparatus for controlling a multicarrier light source generator in accordance with an example of the present disclosure.

FIG. 2 is a reference view illustrating a spectrum of light output when two light sources are input into a multicarrier light source generator in accordance with an example of the present disclosure.

FIG. 3 is a reference view illustrating a spectrum of light output when three light sources are input into a multicarrier light source generator in accordance with an example of the present disclosure.

FIG. 4 is a reference view illustrating a spectrum of light output when four light sources are input into a multicarrier light source generator in accordance with an example of the present disclosure.

FIG. 5 is a flowchart showing a method of controlling a multicarrier light source generator in accordance with an embodiment of the present disclosure.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness. In addition, terms described below are terms defined in consideration of functions in the present invention and may be changed according to the intention of a user or an operator or conventional practice. Therefore, the definitions must be based on contents throughout this disclosure.

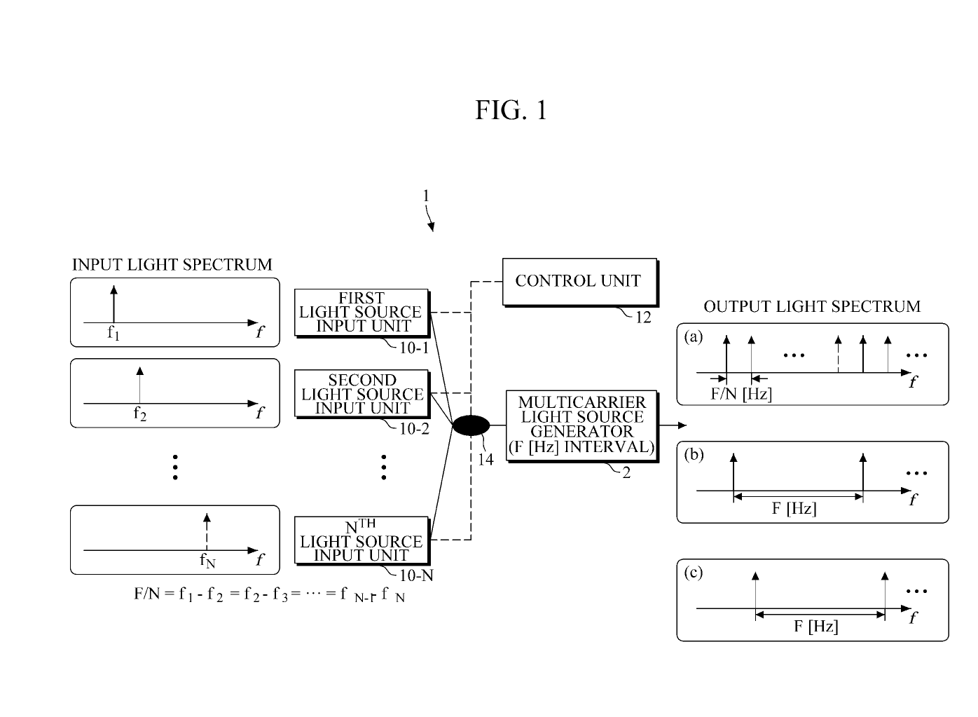

FIG. 1 is a block diagram illustrating an apparatus 1 for controlling a multicarrier light source generator in accordance with an example of the present disclosure.

Referring to FIG. 1, the apparatus 1 for controlling a multicarrier light source generator may include N-light source input units 10-1, 10-2, . . . , and 10-N, and a control unit 12, and further include an optical combiner 14.

As a representative technology for improving the transmission capacity of an optical communication network, a wavelength division multiplexing (hereinafter, referred to as WDM) optical transmission system is used. The WDM optical transmission system requires a plurality of light sources having a constant frequency interval, and to this end, a multicarrier light source generator 2 is provided. The multicarrier light source generator 2 generates multicarrier light sources at a constant frequency interval of F [Hz].

With entering the current information age, the optical communication network has evolved into more complex and various forms. To satisfy the complex and various requirements of the optical communication network, a multicarrier generating technology needs to be developed. In particular, for a flexible optical communication network, a function to freely adjust a frequency interval between carriers is required in a multicarrier generating technology, and the present disclosure relates to a technology for freely adjusting a frequency interval between carriers.

Referring to FIG. 1, the apparatus 1 for controlling the multicarrier light source generator inputs N-light sources having a frequency interval of F/N [Hz] into the multicarrier light source generator 2 that generates multicarrier light sources at a frequency interval of F [Hz]. In FIG. 1, the unit of frequency is represented as [Hz], but may be extended to various units, for example, [GHz].

In detail, the N-light source input units 10-1, 10-2, . . . , and 10-N input light sources into the multicarrier light source generator 2 that generates multicarrier light sources at a frequency interval of F [Hz]. In this case, the control unit 12 adjusts the frequency interval between the respective light sources input from the N-light source input units 10-1, 10-2, . . . and 10-N as F/N [Hz], thereby adjusting the frequency interval between the multicarrier light sources generated from the multicarrier light source generator 2. For example, as shown in FIG. 1, the frequency interval is adjusted as F/N=f₁−f₂=f₂−f₃= . . . =f_{N-1}−f_{N}.

The control unit 12 controls the operation of the N-light source input units 10-1, 10-2, . . . and 10-N, thereby adjusting wavelengths and light intensities of the light sources input into the multicarrier light source generator 2. In accordance with an example of the present disclosure, the control unit 12 selects a light source, which is to be input into the multicarrier light source generator 2, among light sources generated from the N-light source input units 10-1, 10-2, . . . and 10-N by selectively switching on/off the N-light source input units 10-1, 10-2, . . . and 10-N, such that the frequency interval between the multicarrier light source generated from the multicarrier light source generator 2 is freely adjusted.

In accordance with an example of the present disclosure, the control unit 12 adjusts the frequency interval between the multicarrier light sources generated from the multicarrier light source generator 2 as kF/N [Hz] (1≦k≦N, k is an integer and a divisor of N) by selectively switching on/off the N-light source input units 10-1, 10-2, . . . and 10-N. For example, in a case in which the number of light source input units is 4, frequency intervals of multicarrier light sources generated from the multicarrier light source generator 2 may be adjusted as F/4 [Hz], F/2(2F/4) [Hz], and F(4F/4) [Hz]. When a light source that is to be input into the multicarrier light source generator 2 is selected, the control unit 12 may select the light source based on a frequency or a frequency interval that is desired by a command of a user.

The optical combiner 14 combines light sources generated from the N-light source input units 10-1, 10-2, . . . and 10-N, and inputs the combined light sources into the multicarrier light source generator 2. The optical combiner 14 may represent an optical coupler or an array wave guide, but is not limited thereto.

According to the result of adjusting the frequency interval by the apparatus 1 for controlling the multicarrier light source generator, the multicarrier light source generator 2 may output an optical spectrum that generates multicarrier light sources at a frequency interval of F/N [Hz] as shown in FIG. 1 (a).

If the control unit 12, in order to adjust the interval between wavelengths, switches off all the light source input units 10-2, 10-3, . . . and 10-N except a first light source input unit 10-1, the multicarrier light source generator 2 may output an optical spectrum having a frequency interval of F [Hz] as shown in FIG. 1 (b).

Even if the control unit 12 switches off all the light source input units except one light source input unit other than the first light source input unit 10-1, a multicarrier optical spectrum having a frequency interval of F [Hz] is output. In this case, a start frequency may be slightly shifted depending on the frequency of an input light source. For example, the optical spectrum output when only a second light source input unit 10-2 is switched on is shown in FIG. 1 (c).

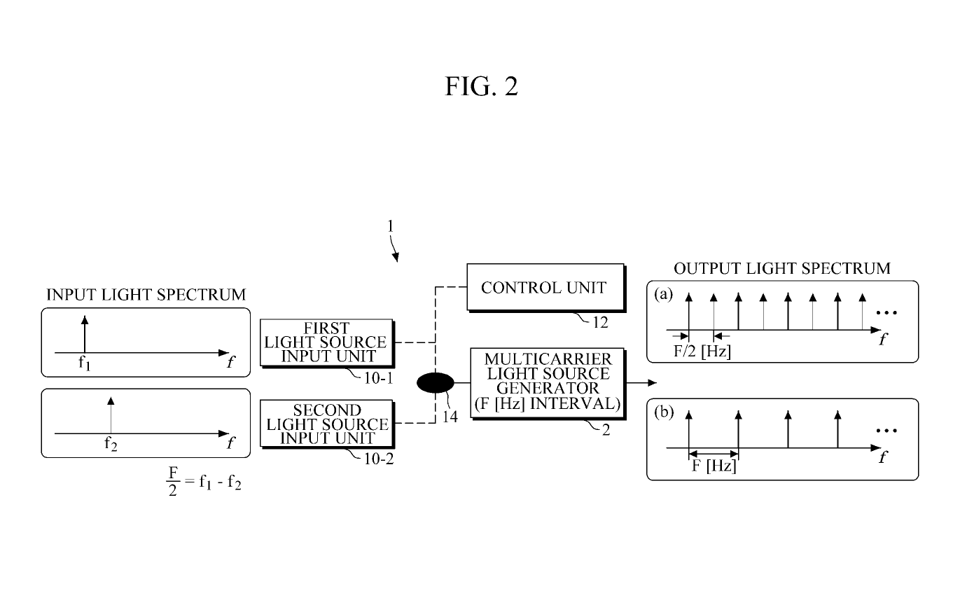

By selectively switching on/off the N-light source input units 10-1, 10-2, . . . and 10-N, the frequency intervals between multicarrier light sources generated from the multicarrier light source generator 2 is freely adjusted. Hereinafter, various examples of adjusting the frequency interval will be described with reference to FIGS. 2 to 4.

FIG. 2 is a reference view illustrating a spectrum of light output when two light sources are input into the multicarrier light source generator 2 in accordance with an example of the present disclosure.

Referring to FIG. 2, when light sources are input into the multicarrier light source generator 2 through the first light source input unit 10-1 and the second light source input unit 10-2 and the multicarrier light source generator 2 generates light sources having a frequency interval of F [Hz], the light sources input from the two light source input units 10-1 and 10-2 are set to have a frequency interval of F/2 [Hz] and are input into the multicarrier light source generator 2. That is, F/2=f₁−f₂.

When both of the two light source input units 10-1 and 10-2 are switched on, the multicarrier light source generator 2 outputs an optical spectrum that generates multicarrier light sources having a frequency interval of F/2 [Hz] as shown in FIG. 2 (a).

On the other hand, when the first light source input unit 10-1 is switched on and the second light source input unit 10-2 is switched off, the multicarrier light source generator 2 is outputs an optical spectrum that generates multicarrier light sources having a frequency interval of F [Hz] as shown in FIG. 2 (b).

Further, when the second light source input unit 10-2 is switched on and the first light source input unit 10-1 is switched off, the multicarrier light source generator 2 outputs an optical spectrum that generates multicarrier light sources having a frequency interval of F [Hz], as shown in FIG. 2 (b), but each of the generated multicarrier light sources is shifted by F/2 [Hz].

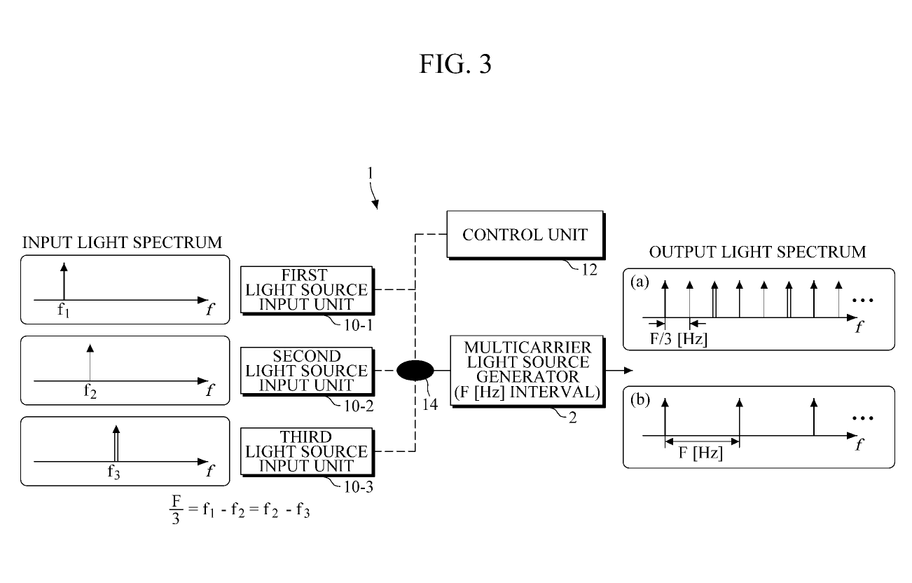

FIG. 3 is a reference view illustrating a spectrum of light output when three light sources are input into the multicarrier light source generator 2 in accordance with an example of the present disclosure.

Referring to FIG. 3, when light sources are input into the multicarrier light source generator 2 through a first light source input unit 10-1, a second light source input unit 10-2, and a third light source input unit 10-3 and the multicarrier light source generator 2 generates light sources having a frequency interval of F [Hz], the light sources input from the three light source input units 10-1, 10-2, and 10-3 are set to have a frequency interval of F/3 [Hz] and are input into the multicarrier light source generator 2. That is, F/3=f₁−f₂=f₂−f₃.

When all of the three light source input units 10-1, 10-2, and 10-3 are switched on, the multicarrier light source generator 2 outputs an optical spectrum that generates multicarrier light sources having a frequency interval of F/3 [Hz] as shown in FIG. 3 (a).

On the other hand, when the first light source input unit 10-1 is switched on and the second and third light source input units 10-2 and 10-3 are switched off, the multicarrier light source generator 2 outputs an optical spectrum that generates multicarrier light sources having a frequency interval of F [Hz] as shown in FIG. 3 (b).

Further, when the second light source input unit 10-2 is switched on and the first and third light source input units 10-1 and 10-3 are switched off, the multicarrier light source generator 2 outputs an optical spectrum that generates multicarrier light sources having a frequency interval of F [Hz], as shown in FIG. 3 (b), but each of the generated multicarrier light sources is shifted by F/2 [Hz].

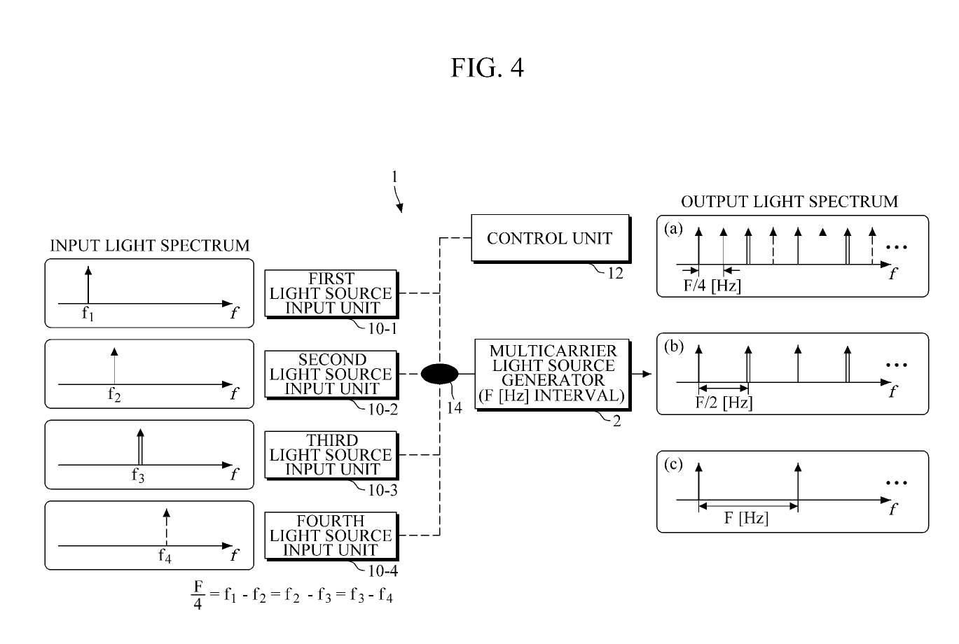

FIG. 4 is a reference view illustrating a spectrum of light output when four light sources are input into the multicarrier light source generator 2 in accordance with an example of the present disclosure.

Referring to FIG. 4, when light sources are input into the multicarrier light source generator 2 through a first light source input unit 10-1, a second light source input unit 10-2, a third light source input unit 10-3, and a fourth light source input unit 10-4 and the multicarrier light source generator 2 generates light sources having a frequency interval of F [Hz], the light sources input from the four light source input units 10-1, 10-2, 10-3, and 10-4 are set to have a frequency interval of F/4 [Hz] and are input into the multicarrier light source generator 2. That is, F/4=f₁−f₂=f₂−f₃=f₃−f₄.

When all of the four light source input units 10-1, 10-2, 10-3, and 10-4 are switched on, the multicarrier light source generator 2 outputs an optical spectrum that generates multicarrier light sources having a frequency interval of F/4 [Hz] as shown in FIG. 4 (a).

On the other hand, when the first and third light source input units 10-1 and 10-3 are switched on and the second and fourth light source input units 10-2 and 10-4 are switched off, the multicarrier light source generator 2 outputs an optical spectrum that generates multicarrier light sources having a frequency interval of F/2 [Hz] as shown in FIG. 4 (b).

Further, when the first light source input unit 10-1 is switched on and all the remaining light source input units 10-2, 10-3, and 10-4 are switched off, the multicarrier light source generator 2 outputs an optical spectrum that generates multicarrier light sources having a frequency interval of F [Hz] as shown in FIG. 4 (c).

As described above with reference to the above examples of the present disclosure, N-light sources having a frequency interval of F/N [Hz] are input into the multicarrier light source generator 2 having a frequency interval of F [Hz], thereby producing the multicarrier light source generator 2 capable of adjusting the frequency interval. In this case, by selectively switching on/off an input light source by use of a control circuit, the frequency interval may be freely adjusted.

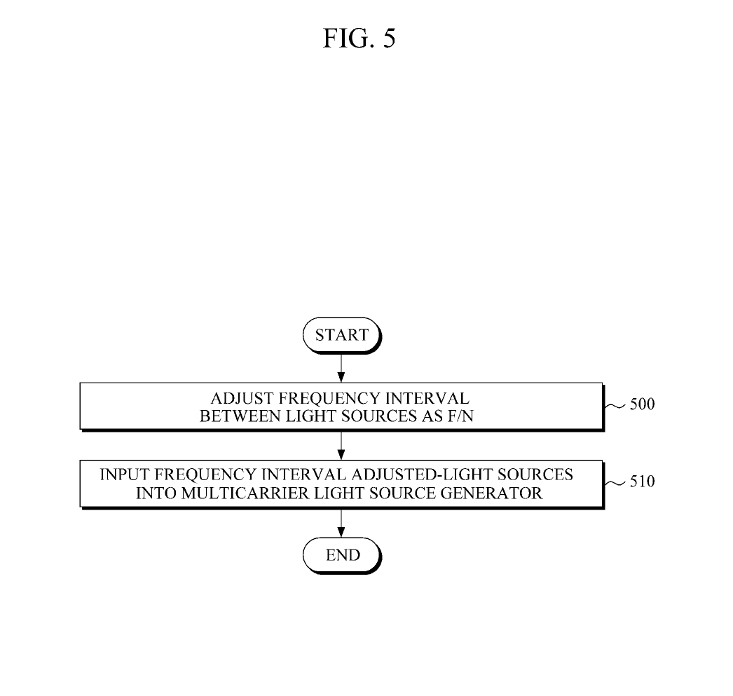

FIG. 5 is a flowchart showing a method of controlling a multicarrier light source generator in accordance with an embodiment of the present disclosure.

Referring to FIGS. 1 and 5, the control unit 12 of the apparatus 1 for controlling the multicarrier light source generator adjusts a frequency interval between light sources as F/N [Hz] in operation 500. Thereafter, the light sources, the frequency interval of which is adjusted, are input into the multicarrier light source generator 2 that generates multicarrier light sources at a frequency interval of F [Hz] through N-light source input units 10-1, 10-2, . . . and 10-N, thereby adjusting a frequency interval of the multicarrier light sources generated from the multicarrier light source generator 2 in operation 510.

In accordance with an example of the present disclosure, in the adjusting of the frequency interval between the multicarrier light sources of operation 510, the control unit 12 selects a light source that is to be input into the multicarrier light source generator 2 among light sources generated from the N-light source input units 10-1, 10-2, . . . and 10-N by selectively switching on/off the N-light source input units 10-1, 10-2, . . . and 10-N, such that the frequency interval between the multicarrier light sources generated from the multicarrier light source generator 2 is adjusted.

In accordance with an example of the present disclosure, in the adjusting of the frequency interval between the multicarrier light sources of operation 510, the control unit 12 adjusts the frequency interval between the multicarrier light sources generated from the multicarrier light source generator 2 as kF/N [Hz] (1≦k≦N, k is an integer and a divisor of N) by selectively switching on/off the N-light source input units 10-1, 10-2, . . . and 10-N.

In accordance with an example of the present disclosure, in the adjusting of the frequency interval between the multicarrier light sources of operation 510, the control unit 12, when selecting a light source that is to be input into the multicarrier light source generator 2, selects the light source based on a frequency or a frequency interval that is desired by a command of a user.

Further, the method for controlling the multicarrier light source generator may further include combining light sources generated from the N-light source input units 10-1, 10-2, . . . and 10-N using the optical combiner 14, and in the adjusting of the frequency interval between the multicarrier light sources of operation 510, the light sources combined through the optical combiner 14 are input into the multicarrier light source generator 2.

The present invention can be implemented as computer readable codes in a computer readable record medium. The computer readable record medium includes all types of record media in which computer readable data are stored. Examples of the computer readable record medium include a ROM, a RAM, a CD-ROM, a magnetic tape, a floppy disk, and an optical data storage. Further, the record medium may be implemented in the form of a carrier wave such as Internet transmission. In addition, the computer readable record medium may be distributed to computer systems over a network, in which computer readable codes may be stored and executed in a distributed manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for controlling a multicarrier light source generator, the apparatus comprising:
N-light source input units configured to input light sources to a multicarrier light source generator that generates multicarrier light sources at a frequency interval of F [Hz]; and
a control unit configured to adjust the frequency interval of the multicarrier light sources generated from the multicarrier light source generator, by adjusting a frequency interval between the light sources input from the N-light source input unit as F/N [Hz].

2. The apparatus of claim 1, wherein the control unit selects a light source, which is to be input into the multicarrier light source generator, among light sources generated from the N-light source input units by selectively switching on/off the N-light source input units, such that the frequency interval between the multicarrier light sources generated from the multicarrier light source generator is adjusted.

3. The apparatus of claim 2, wherein the control unit adjusts the frequency interval between the multicarrier light sources generated from the multicarrier light source generator as kF/N [Hz] (1≦k≦N, k is an integer and a divisor of N) by selectively switching on/off the N-light source input units.

4. The apparatus of claim 2, wherein the control unit, when selecting a light source which is to be input into the multicarrier light source generator, selects the light source based on a frequency or a frequency interval that is desired by a user command.

5. The apparatus of claim 1, wherein the control unit adjusts wavelengths and intensities of light sources that are input into the multicarrier light source generator, by controlling an operation of the N-light source input units.

6. The apparatus of claim 1, further comprising an optical combiner configured to combine light sources generated from the N-light source input units, and input the combined light sources into the multicarrier light source generator.

7. A method of controlling a multicarrier light source generator, the method comprising:
adjusting a frequency interval of light sources as F/N [Hz]; and
adjusting a frequency interval of multicarrier light sources generated from a multicarrier light source generator that generates multicarrier light sources at a frequency interval of F [Hz], by inputting the light sources, the frequency interval of which is adjusted, into the multicarrier light source generator through N-light source input units.

8. The method of claim 7, wherein in the adjusting of the frequency interval of the multicarrier light sources, a light source which is to be input into the multicarrier light source generator is selected among light sources generated from the N-light source input units by selectively switching on/off the N-light source input units, such that the frequency interval between the multicarrier light sources generated from the multicarrier light source generator is adjusted.

9. The method of claim 8, wherein in the adjusting of the frequency interval of the multicarrier light sources, the frequency interval between the multicarrier light sources generated from the multicarrier light source generator is adjusted as kF/N [Hz] (1≦k≦N, k is an integer and a divisor of N) by selectively switching on/off the N-light source input units.

10. The method of claim 8, wherein in the adjusting of the frequency interval of the multicarrier light sources, when a light source which is to be input into the multicarrier light source generator is selected, the light source is selected based on a frequency or a frequency interval that is desired by a command of a user.

11. The method of claim 7, further comprising combining light sources generated from the N-light source input units using an optical combiner,
wherein in the adjusting of the frequency interval of the multicarrier light sources, light sources combined through the optical combiner are input into the multicarrier light source generator.
